(19) United States
(12) Patent Application Publication
(10) Pub. No.: US 2003/0053460 A1
(43) Pub. Date: Mar. 20, 2003

(54) Packet forwarding processing device

(75) Inventors: Yukinori Suda, Tokyo (JP); Yasuhiko Matsunaga, Tokyo (JP)

Correspondence Address: FOLEY AND LARDNER, SUITE 500, 3000 K STREET NW, WASHINGTON, DC, 20007, US

(73) Assignee: NEC CORPORATION

(21) Appl. No.: 10/244,511

(22) Filed: Sep. 17, 2002

(30) Foreign Application Priority Data
Sep. 18, 2001 (JP) 2001-282839

(51) Int. Cl. H04L 12/28; H04L 12/56

(52) U.S. Cl. 370/392

(57) ABSTRACT

Header information is stored in a data register through an external interface, branch condition information including a classification order is stored in a branch condition register and information about a combination of fields of classification conditions to be applied is stored in a combination register. A conversion circuit and a sequencer extract only a necessary field from header information to generate a search key based on the branch condition information and the combination information. A CAM controller conducts search processing for a CAM by using the search key. The sequencer determines whether there exists packet classification to be executed next based on a search result and the branch condition information.

### BACKGROUND OF THE INVENTION

1. Field of the Invention

The present invention relates to a packet processing technique and, more particularly, to a packet forwarding processing device for conducting packet classification using dedicated hardware. 2. Description of the Related Art

In recent years, high-speed IP (Internet Protocol) access systems have been rapidly gaining popularity whose representatives are CATV access and xDSL. Details of CATV access and xDSL are recited in, for example, Nikkei Communication Vol. 316, April 2000.

With these high-speed IP access systems, although the main stream is the best-effort type Internet connection service, provision of IP-based telephone and video services is expected.

For providing the IP telephone service, in particular, as public connection service incurring charges for each communication, it is essential to ensure service quality and security as high as or higher than those of the subscriber's telephone service. Therefore, an edge node which directly accommodates a modem at a subscriber's home needs to discriminate a packet for each subscriber/service to conduct QoS/policy control and packet forwarding processing according to a classification result.

Packet classification here represents processing of comparison with packet classification conditions registered in a data base in advance by using an arbitrary field of a packet header or a search key generated by combining arbitrary fields. Although an edge node sequentially conducts packet filtering, packet forwarding and flow classification as required, since different search keys are used according to a purpose of use, it needs to successively conduct packet classification using different search keys a plurality of times.

It is in general known that when conducting packet classification as hardware processing, use of a mask CAM (content addressable memory) as a memory for holding packet classification conditions enables speed-up of packet classification. Packet classification using a mask CAM is recited in detail, for example, in A. McAuley, et al., “Fast Routing Table Lookup Using CAMs”, IEEE Infocom '93, San Francisco, USA, 1993.

Since packet classification devices using a CAM have hardware designed to be specialized for use in packet classification, with importance attached to speed-up of packet classification, packet classification using predetermined search keys is conducted in a pipeline manner in a predetermined order.

Packet classification using an ASIC or an FPGA is also proposed. In an FPGA, an internal RAM can be logically composed as a CAM, and hardware using such an FPGA realizes a function equivalent to that of hardware using a CAM IC. An FPGA having a CAM provided therein is recited in detail, for example, in

http://www.xilinx.co.jp/xapp/j_xapp201_{—}1_{—}2.pdf.

These packet classification devices using dedicated hardware tend to have a small storage region for storing packet classification conditions due to constraints on hardware.

On the other hand, Japanese Patent Laying-Open (Kokai) No. Heisei 11-331268 recites a packet relay device in which with respect to a received packet, a search engine searches a flow data base for an entry corresponding to a key generated according to conditions that can be variably set for each protocol. This packet relay device, however, conducts only one packet classification (routing processing) for one received packet as hardware processing and a plurality of times of packet classification for one received packet are executed not in hardware but in software.

Packet forwarding processing devices which conduct conventional packet classification have the following problems.

First problem is that when newly adding packet classification which requires a different search key or when changing a search key, hardware should be modified. The reason is that the devices are designed to have such timing that packet classifications using predetermined search keys are conducted in a predetermined order for the purpose of speeding up processing.

Second problem is that the order of a plurality of packet classifications using different search keys can not be dynamically changed. The reason is that the devices are designed to have such hardware that packet classifications using predetermined search keys are conducted in a predetermined order for the purpose of speeding up processing.

Third problem is that packet classification to be executed next can not be dynamically changed according to a result of immediately preceding packet classification. The reason is that the devices are designed to have such hardware that packet classifications using predetermined search keys are conducted in a predetermined order for the purpose of speeding up processing.

Fourth problem is that a region for storing packet classification conditions is small. The reason is constraint on hardware.

Fifth problem is that in packet classification using a mask CAM, when a part of fields of packet classification conditions needs to be designated as a range of numerical values, storage efficiency might be degraded depending on a value of the numerical value range. The reason is that since each entry set at the mask CAM should be represented in a (data, mask) format without fail, depending on a value of a designated numerical value range, numbers of entries will be required even for one packet classification condition.

### SUMMARY OF THE INVENTION

Thus, a first object of the present invention is to provide a packet processing device enabling addition of new packet classification using a different search key or change of a search key without changing hardware.

A second object of the present invention is to provide a packet processing device enabling the order of a plurality of packet classifications using different search keys to be changed dynamically without modifying hardware.

A third object of the present invention is to provide a packet processing device enabling packet classification which is to be executed next to be changed dynamically according to a result of immediately preceding packet classification without modifying hardware.

A fourth object of the present invention is to provide a packet processing device which uses a storage region for packet classification conditions efficiently.

According to the first aspect of the invention, a packet forwarding processing device having a packet classifier for executing, based on header information of an applied packet and a plurality of predetermined packet classification conditions, a plurality of kinds of packet classifications using different search keys with respect to the packet, wherein

the packet classifier includes means for generating a search key for use in each of the plurality of kinds of packet classifications based on combination information indicative of a combination of fields of header information for each of the plurality of kinds of packet classifications externally designated and the header information of the packet.

In the preferred construction, the packet classifier has a storage region for storing a plurality of packet classification conditions, the storage region storing only a value of a field necessary for packet classification among the respective fields of header information of a packet as packet classification conditions.

In another preferred construction, the packet classification conditions include a numerical value range represented by a lower limit value and an upper limit value, and as to a part of the numerical value range in the packet classification conditions, when a numerical value indicated by a relevant part of a search key falls within the numerical value range, the packet classifier determines that the part of the numerical value range in the packet classification conditions and the relevant part of the search key coincide with each other.

According to the second aspect of the invention, a packet forwarding processing device having a packet classifier for executing, based on header information of an applied packet and a plurality of predetermined packet classification conditions, a plurality of kinds of packet classifications using different search keys with respect to the packet, wherein

the packet classifier includes means for, at every execution of packet classification, based on a result of the executed processing and branch condition information indicative of a corresponding relationship between a result of each of the kinds of packet classifications externally designated and processing to be executed next, ending processing of the packet or executing packet classification of a kind instructed to be executed next by the branch condition information.

In the preferred construction, the packet classifier has a storage region for storing a plurality of packet classification conditions, the storage region storing only a value of a field necessary for packet classification among the respective fields of header information of a packet as packet classification conditions.

In another preferred construction, the packet classification conditions include a numerical value range represented by a lower limit value and an upper limit value, and as to a part of the numerical value range in the packet classification conditions, when a numerical value indicated by a relevant part of a search key falls within the numerical value range, the packet classifier determines that the part of the numerical value range in the packet classification conditions and the relevant part of the search key coincide with each other.

According to the third aspect of the invention, a packet forwarding processing device having a packet classifier for executing, based on header information of an applied packet and a plurality of predetermined packet classification conditions, a plurality of kinds of packet classifications using different search keys with respect to the packet, wherein

the packet classifier includes means for, at every execution of packet classification, based on a result of the executed processing and branch condition information indicative of a corresponding relationship between a result of each of the kinds of packet classifications externally designated and processing to be executed next, ending processing of the packet, or executing packet classification of a kind instructed to be executed next by the branch condition information by using a search key generated based on the header information and combination information indicative of a combination of fields of header information for each of the plurality of kinds of packet classifications externally designated.

In the preferred construction, the packet classifier has a storage region for storing a plurality of packet classification conditions, the storage region storing only a value of a field necessary for packet classification among the respective fields of header information of a packet as packet classification conditions.

In another preferred construction, the packet classification conditions include a numerical value range represented by a lower limit value and an upper limit value, and as to a part of the numerical value range in the packet classification conditions, when a numerical value indicated by a relevant part of a search key falls within the numerical value range, the packet classifier determines that the part of the numerical value range in the packet classification conditions and the relevant part of the search key coincide with each other.

According to another aspect of the invention, a packet classifier for executing, based on header information of an applied packet and a plurality of predetermined packet classification conditions, a plurality of kinds of packet classifications using different search keys with respect to the packet, comprises

means for generating a search key for use in each of the plurality of kinds of packet classifications based on combination information indicative of a combination of fields of header information for each of the plurality of kinds of packet classifications externally designated and the header information of the packet.

In the preferred construction, the packet classifier has a storage region for storing a plurality of packet classification conditions, the storage region storing only a value of a field necessary for packet classification among the respective fields of header information of a packet as packet classification conditions.

In another preferred construction, the packet classification conditions include a numerical value range represented by a lower limit value and an upper limit value, and as to a part of the numerical value range in the packet classification conditions, when a numerical value indicated by a relevant part of a search key falls within the numerical value range, the packet classifier determines that the part of the numerical value range in the packet classification conditions and the relevant part of the search key coincide with each other.

According to another aspect of the invention, a packet classifier for executing, based on header information of an applied packet and a plurality of predetermined packet classification conditions, a plurality of kinds of packet classifications using different search keys with respect to the packet, comprises

means for, at every execution of packet classification, based on a result of the executed processing and branch condition information indicative of a corresponding relationship between a result of each of the kinds of packet classifications externally designated and processing to be executed next, ending processing of the packet or executing packet classification of a kind instructed to be executed next by the branch condition information.

In the preferred construction, the packet classifier has a storage region for storing a plurality of packet classification conditions, the storage region storing only a value of a field necessary for packet classification among the respective fields of header information of a packet as packet classification conditions.

In another preferred construction, the packet classification conditions include a numerical value range represented by a lower limit value and an upper limit value,.and as to a part of the numerical value range in the packet classification conditions, when a numerical value indicated by a relevant part of a search key falls within the numerical value range, the packet classifier determines that the part of the numerical value range in the packet classification conditions and the relevant part of the search key coincide with each other.

According to a further aspect of the invention, a packet classifier for executing, based on header information of an applied packet and a plurality of predetermined packet classification conditions, a plurality of kinds of packet classifications using different search keys with respect to the packet, comprises

means for, at every execution of packet classification, based on a result of the executed processing and branch condition information indicative of a corresponding relationship between a result of each of the kinds of packet classifications externally designated and processing to be executed next, ending processing of the packet, or executing packet classification of a kind instructed to be executed next by the branch condition information by using a search key generated based on the header information and combination information indicative of a combination of fields of header information for each of the plurality of kinds of packet classifications externally designated.

In the preferred construction, the packet classifier has a storage region for storing a plurality of packet classification conditions, the storage region storing only a value of a field necessary for packet classification among the respective fields of header information of a packet as packet classification conditions.

In another preferred construction, the packet classification conditions include a numerical value range represented by a lower limit value and an upper limit value, and as to a part of the numerical value range in the packet classification conditions, when a numerical value indicated by a relevant part of a search key falls within the numerical value range, the packet classifier determines that the part of the numerical value range in the packet classification conditions and the relevant part of the search key coincide with each other.

Other objects, features and advantages of the present invention will become clear from the detailed description given herebelow.

### BRIEF DESCRIPTION OF THE DRAWINGS

The present invention will be understood more fully from the detailed description given herebelow and from the accompanying drawings of the preferred embodiment of the invention, which, however, should not be taken to be limitative to the invention, but are for explanation and understanding only.

In the drawings:

FIG. 1 is a block diagram showing an example of a structure of a packet forwarding processing device 1200;

FIG. 2 is a block diagram showing an example of a structure of dedicated hardware 10 for use in explaining a first embodiment of the present invention;

FIG. 3 is a block diagram showing an example of a structure of a CAM controller 20 for use in explaining the first embodiment of the present invention;

FIG. 4 is a system diagram of a CAM 30 for use in explaining the first embodiment of the present invention;

FIG. 5 is a flow chart showing an example of processing conducted by a processor 1210;

FIG. 6 is a flow chart showing an example of processing conducted by a sequencer 110;

FIG. 7 is a flow chart showing an example of processing conducted by a conversion circuit 100;

FIG. 8 is a diagram showing data in the CAM for use in explaining the first embodiment of the present invention;

FIG. 9 is an operation flow diagram for use in explaining branch condition information;

FIG. 10 is a diagram showing one example of branch condition information;

FIG. 11 is a block diagram showing an example of a structure of dedicated hardware 10a for use in explaining a second embodiment of the present invention;

FIG. 12 is a block diagram showing an example of a structure of a gate array 60 for use in explaining the second embodiment of the present invention;

FIG. 13 is a diagram showing data in a memory for use in explaining the second embodiment of the present invention;

FIG. 14 is a diagram showing L4 header data for use in explaining the second embodiment of the present invention;

FIG. 15 is a block diagram showing an example of a structure of a decision circuit 440 for use in explaining the second embodiment of the present invention;

FIG. 16 is a diagram showing an input/output table of a comparator 900 for use in explaining the second embodiment of the present invention;

FIG. 17 is a diagram showing an input/output table of a comparator 910 for use in explaining the second embodiment of the present invention;

FIG. 18 is a diagram showing a truth table of an L4 decision unit 990 for use in explaining the second embodiment of the present invention; and

FIG. 19 is a diagram showing a frame format of a packet for use in explaining the first and second embodiments of the present invention.

### DESCRIPTION OF THE PREFERRED EMBODIMENTS

The preferred embodiment of the present invention will be discussed hereinafter in detail with reference to the accompanying drawings. In the following description, numerous specific details are set forth in order to provide a thorough understanding of the present invention. It will be obvious, however, to those skilled in the art that the present invention may be practiced without these specific details. In other instance, well-known structures are not shown in detail in order to unnecessary obscure the present invention.

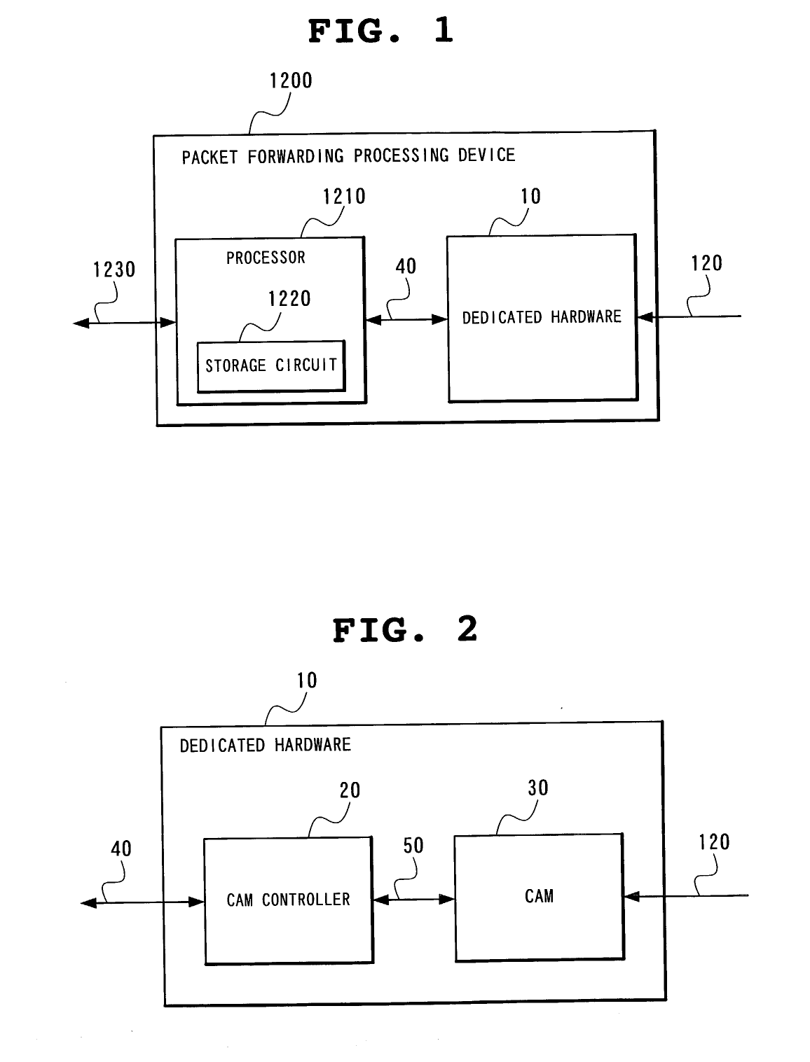

With reference to FIG. 1, a first embodiment of a packet forwarding processing device 1200 according to the present invention will be described. The packet forwarding processing device 1200 includes a processor 1210 having a storage circuit 1220 provided therein such as an RAM and dedicated hardware 10 for conducting packet classification.

The processor 1210 inputs and outputs a packet header through a packet header input/output interface 1230 and is connected to the dedicated hardware 10 through an external interface 40. The dedicated hardware 10 has an external registration interface 120. The dedicated hardware 10 here has a structure shown in FIG. 2, for example.

As illustrated in FIG. 2, the dedicated hardware 10 of the first embodiment is composed of a CAM controller 20 and a CAM 30, with the CAM controller 20 having the external interface 40 and the CAM controller 20 and the CAM 30 being connected to each other through an internal interface 50. In addition, the CAM 30 has the external registration interface 120.

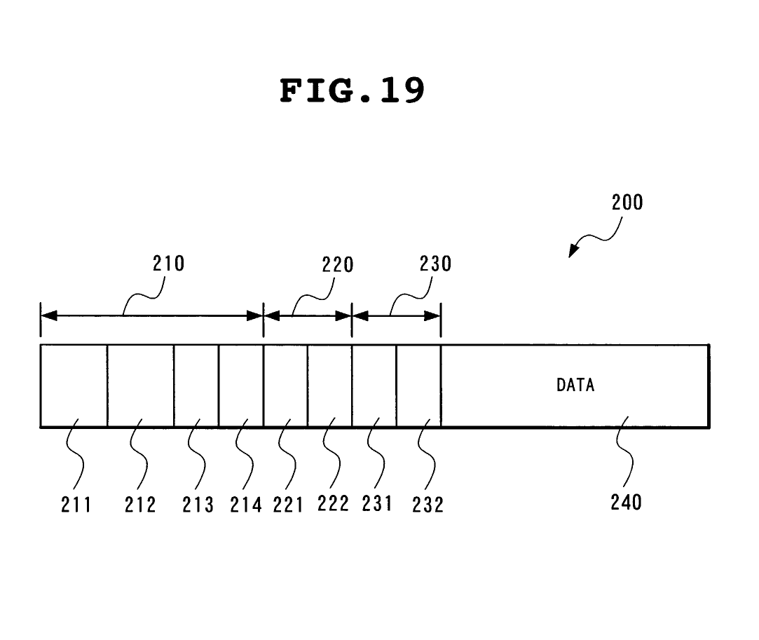

A frame format of a packet whose packet classification is conducted by the packet forwarding processing device 1200 is shown in FIG. 19. A packet frame 200 is composed of L2 (layer 2) header information 210, L3 (layer 3) header information 220, L4 (layer 4) header information 230 and a data frame 240, and the L2 header information 210 is composed of fields #1(211)˜#4(214), the L3 header information 220 is composed of fields #1(221)·#2(222) and the L4 header information 230 is composed of fields #1(231)˜#2(232).

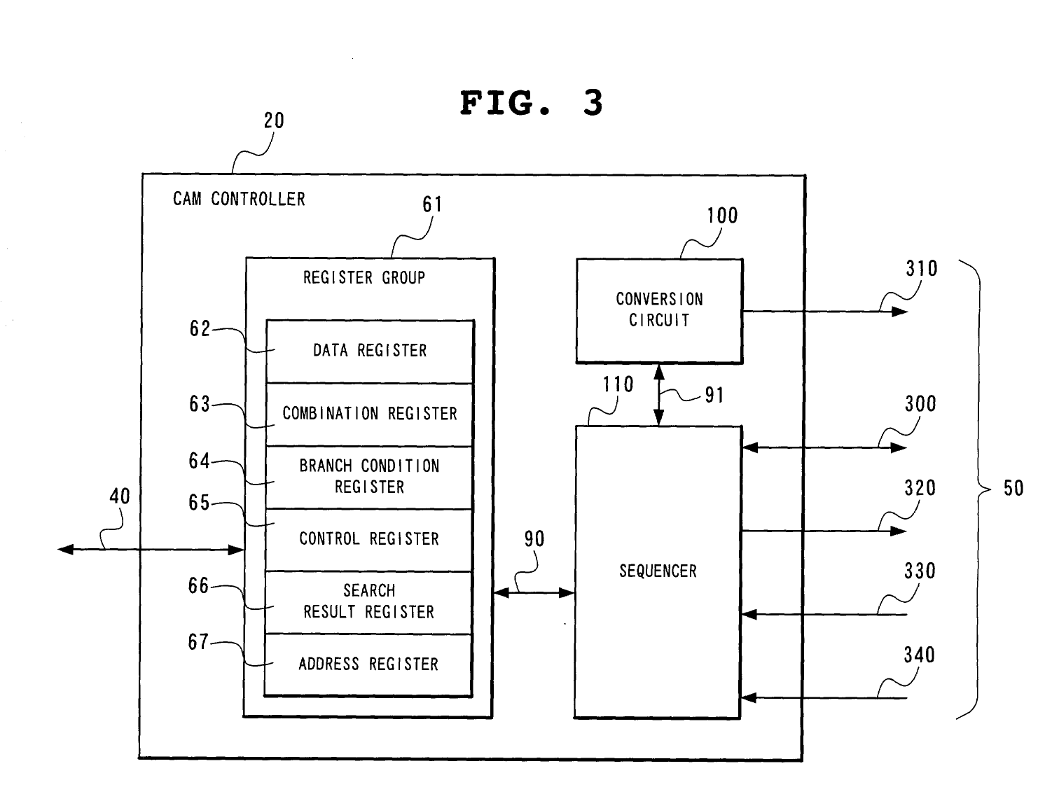

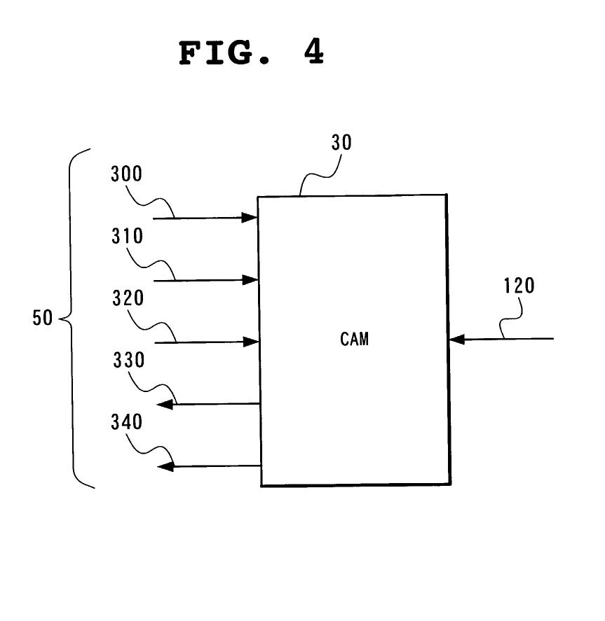

The CAM controller 20 in the dedicated hardware 10 has a structure shown in the block diagram of FIG. 3, for example.

The CAM controller 20 includes a register group 61, a conversion circuit 100 and a sequencer 110. The register group 61 is composed of six registers, a data register 62, a combination register 63, a branch condition register 64, a control register 65, a search result register 66 and an address register 67.

The first data register 62 is a register for holding L2˜L4 header information. The next combination register 63 is a register for holding combination information which designates a field of header information to be applied to packet classification.

The branch condition register 64 is a register for holding branch condition information, which will be described in detail later. The control register 65 is a register for holding a start flag and an end flag for notifying start and end of operation, the search result register 66 is a register for holding a search result (hit or miss) and the last address register 67 is a register for holding a memory address of a packet classification condition coincident with data subjected to search processing.

The sequencer 110 has a function of notifying the contents of the data register 62 and the combination register 63 to the conversion circuit 100, a function of notifying group information in branch condition information held in the branch condition register 64 to the CAM 30, a function of storing a search result and a search address of the CAM 30 in the search result register 66 and the address register 67 and a function of determining processing to be executed next based on the branch condition information stored in the branch condition register 64 and the search results.

In addition, the sequencer 110 is connected to the register group 61 and the conversion circuit 100 through internal interfaces 90 and 91, respectively, and to the CAM 30 through a search control line 300, a group designation data line 320, a search result data line 330 and a search address data line 340.

The conversion circuit 100 has a function of generating a part of search keys for use in packet classification based on the contents of the data register 62 and the combination register 63 notified by the sequencer 110. The conversion circuit 100 is connected to the sequencer 110 through the internal interface 91 and to the CAM 30 through a packet classification condition data line 310.

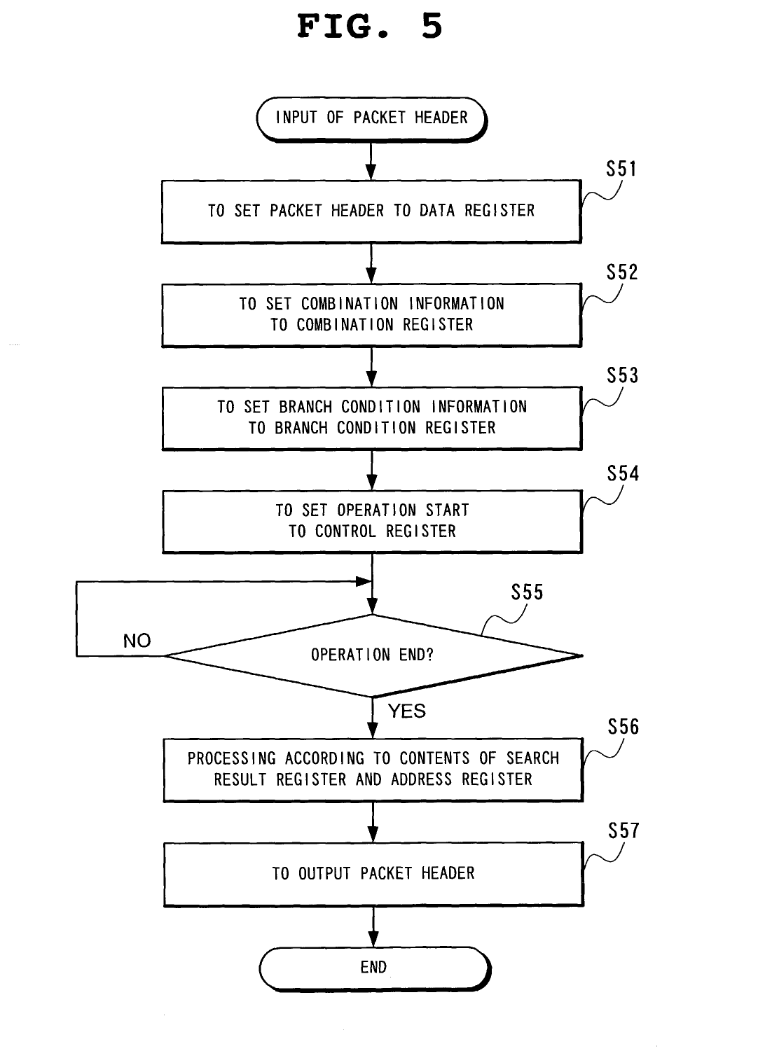

FIG. 4 shows a system diagram of the CAM 30. The CAM 30 is connected to the sequencer 110 through the search control line 300, the group designation data line 320, the search result data line 330 and the search address data line 340 and to the conversion circuit 100 through the packet classification condition data line 310. In addition, the CAM 30 has the external registration interface 120.

Next, operation of the present embodiment will be described.

When a packet header is applied through the packet header input/output interface 1230, software running on the processor 1210 sets header information to the data register 62 through the external interface 40 and furthermore sets combination information and branch condition information of a predetermined field to the combination register 63 and the branch condition register 64, respectively (FIG. 5, Steps S51-S53).

Combination information includes information about combination of fields for each of a plurality of kinds of packet classifications using different search keys which the dedicated hardware 10 can execute for one packet.

When the data is set at each of the registers 62 to 64, set a flag notifying operation start to the control register 65 (Step S54).

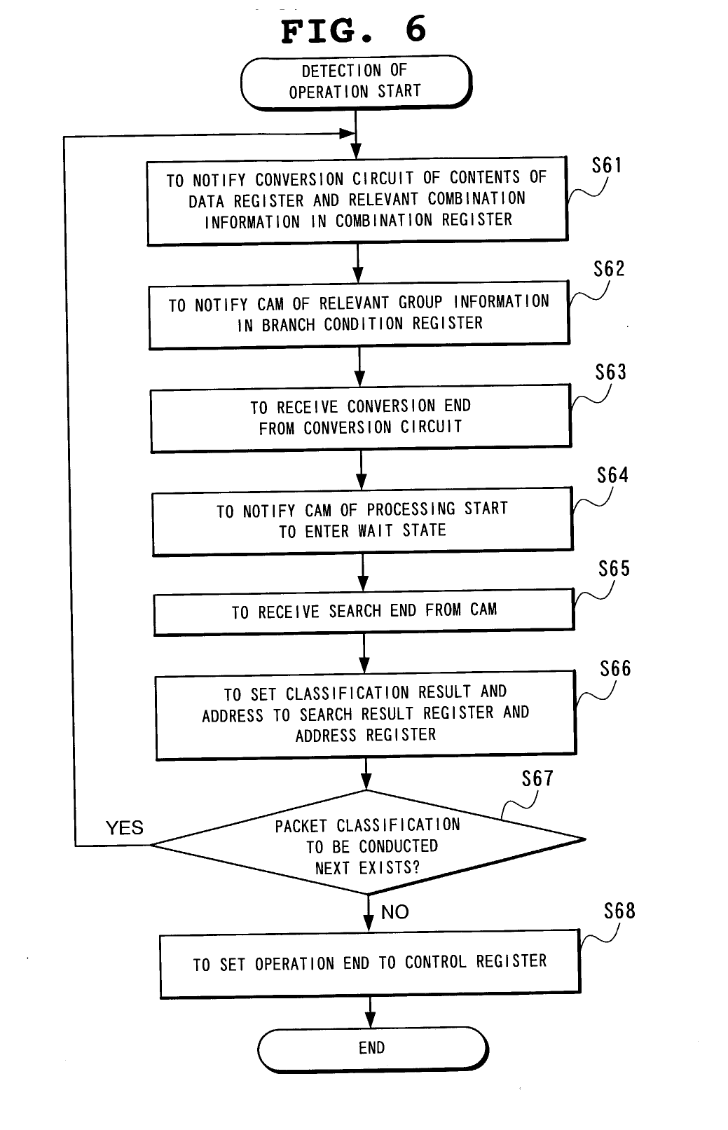

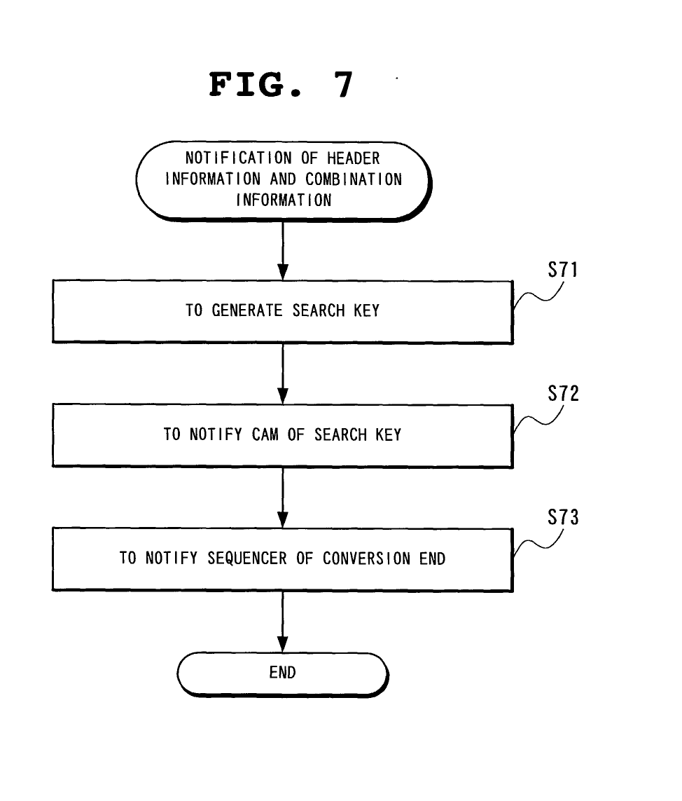

Responsively, the sequencer 110 which reads the contents of the control register 65 in a fixed cycle through the internal interface 90 detects operation start and first reads the information held in the data register 62 and the combination register 63 and then notifies the conversion circuit 100 of the read data through the internal interface 91 (FIG. 6, Step S61). At the time of notifying the combination information, notify information corresponding to packet classification to be conducted first to the conversion circuit 100.

Thereafter, read the branch condition information from the branch condition register 64 and output group information contained in the branch condition information to the group designation data line 320 (Step S62). At the time of output of group information, information corresponding to packet classification to be conducted first is output.

Here, group information and branch condition information will be described in detail.

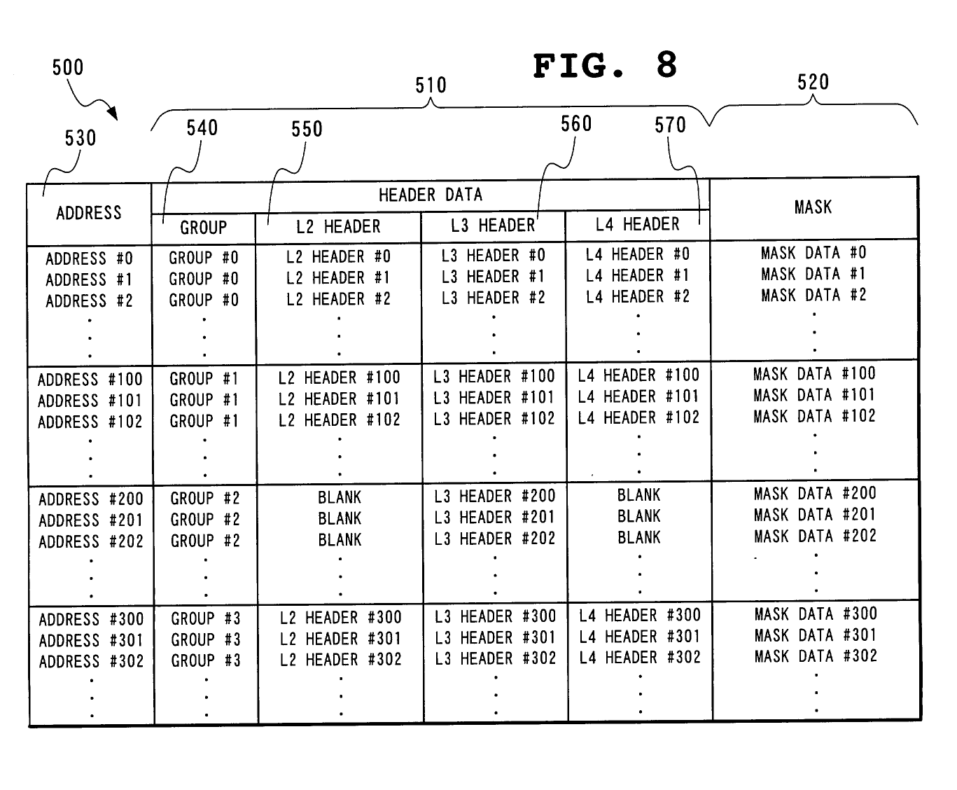

An example of data held by the CAM 30 in the first embodiment is shown in FIG. 8. Data 500 in CAM is composed of a CAM address 530, a CAM data value 510 and a CAM mask value 520, with the CAM data value 510 being composed of a classification condition group 540, L2 header data 550, L3 header data 560 and L4 header data 570.

Here, the CAM address 530 is an address in the CAM 30. Group here represents a group of packet classification conditions. Packet classification conditions vary with each group.

Under packet classification conditions of groups #0,#1 and #3, all the header information of L2 to L4 is designated. On the other hand, under the packet classification condition of the group #2, only the header information of L2 is defined.

Therefore, designating a group number at the time of packet classification enables designation of packet classification conditions which should be subjected to classification. At the time of adding a new packet classification condition, newly generate a group #m with a group number m, put the group #m before data of a packet classification condition to be set and store the obtained condition in the CAM 30. Such processing is conducted using, for example, the external registration interface 120. Group information is used for designating a classification condition group to be applied.

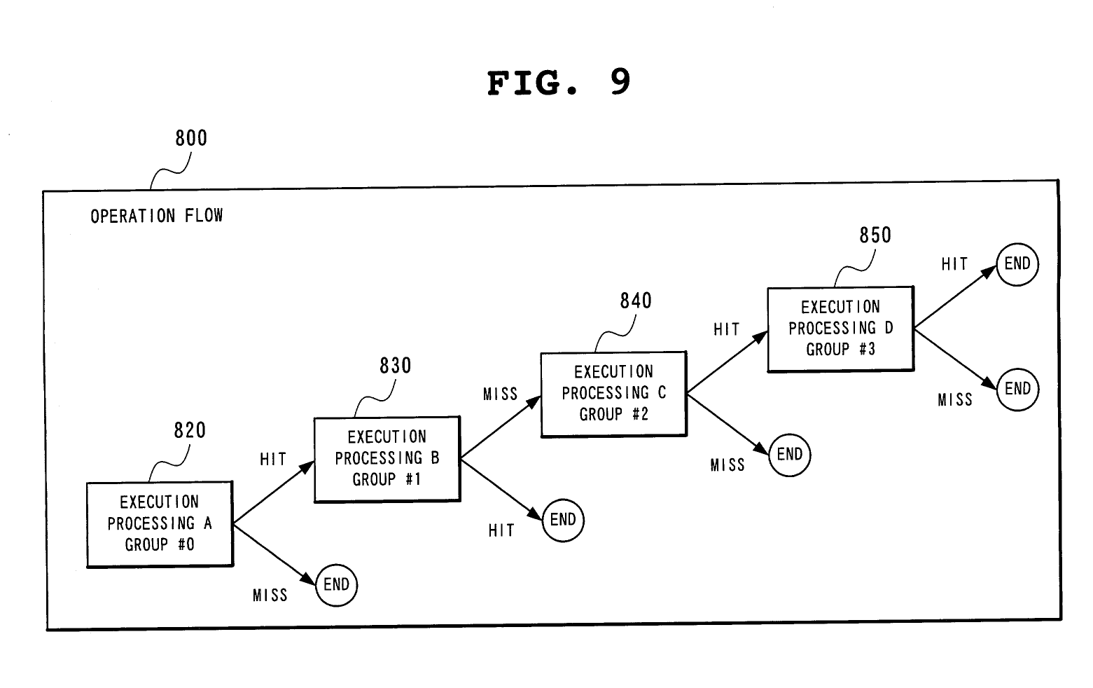

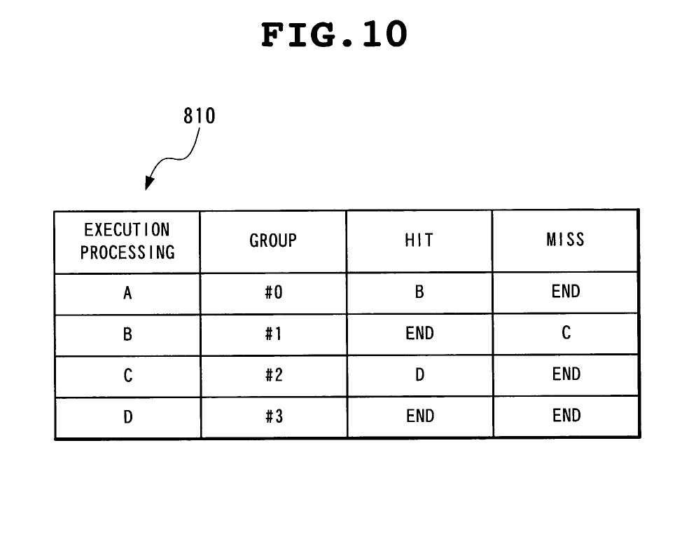

Next, branch condition information will be described in detail. Operation flow and branch condition information in the first embodiment are shown in FIGS. 9 and 10. An operation flow 800 shown in FIG. 9 indicates operation set forth below.

A first execution instruction 820 executes packet classification for the group #0 and when the same packet classification condition exists (hit), subsequently executes a second execution instruction 830. When the same packet classification condition fails to exist (miss), end the processing.

The second execution instruction 830 executes packet classification for the group #1 and when the same packet classification condition exists (hit), ends the processing and when the same packet classification condition fails to exist (miss), subsequently executes a third execution instruction 840.

In addition, the third execution instruction 840 executes packet classification for the group #2 and when the same packet classification condition exists (hit), subsequently executes a fourth execution instruction 850 and when the same packet classification condition fails to exist (miss), ends the processing. After the completion of the processing of the fourth execution instruction 850, end the processing regardless of search results.

In the series of operation, it is possible, for example, to make the first packet classification correspond to packet filtering processing (Permit Filter), the second packet classification to packet filtering processing (Deny Filter), the third packet classification to routing processing and the fourth packet classification to classifier processing.

Putting the operation flow 800 of FIG. 9 into a table obtains branch condition information 810 shown in FIG. 10. In the above-described branch condition register 64, the branch condition information 810 shown in FIG. 10 is held.

Here, again return to the description of the operation. Upon being notified of the header information and the combination information by the sequencer 110 through the internal interface 91, the conversion circuit 100 generates a part of search keys by extracting a field from the header information based on the combination information and after outputting the generated key to the CAM 30 through the packet classification condition data line 310, notifies the sequencer 110 of the end of conversion through the internal interface 91 (FIG. 7, Steps S71 to S73).

Upon receiving the notification of conversion end from the conversion circuit 100 through the internal interface 91 (FIG. 6, Step S63), the sequencer 110 notifies the CAM 30 of processing start through the search control line 300 and then enters a wait state (Step S64).

Upon being notified of processing start by the sequencer 110 through the search control line 300, the CAM 30 connects data (group information) obtained from the sequencer 110 through the group designation data line 320 before the data (field extracted from the header information based on the combination information) obtained from the conversion circuit 100 through the packet classification condition data line 310 to generate a search key.

Using the search key, the CAM 30 conducts search processing for the data 500 in the CAM. The CAM 30 conducts complete coincidence search between all the data therein (data obtained by masking the CAM data value 510 with the CAM mask value 520) and the search key.

As a result, when the data completely coincides with the search key, output hit onto the search result data line 330 and output a CAM address at which the coincident data is to be stored onto the search address data line 340. When the key coincides with a plurality of pieces of data, output the lowest CAM address.

Moreover, when no data completely coincides with the search key, output miss onto the search result data line 330 and output nothing onto the search address data line 340. When the search processing ends, notify the sequencer 110 of search end through the search control line 300.

Upon receiving the search end from the CAM 30 through the search control line 300 (FIG. 6, Step S65), the sequencer 110 at the wait state obtains search result information from the search result data line 330 and address information from the search address data line 340 and sets the information to the search result register 66 and the address register 67, respectively (Step S66).

Moreover, the sequencer 110 reads branch condition information from the branch condition register 64 to determine packet classification to be conducted next based on the branch condition information and the immediately preceding search result information (search result information of the first packet classification).

When packet classification to be conducted next exists (YES at Step S67), notify the conversion circuit 100 of the contents of the data register 62 and combination information for the second packet classification among the contents of the combination register 63 through the internal interface 91, as well as outputting relevant group information (group information for the second packet classification) in the information held in the branch condition register 64 to the group designation data line 320 (Step S61, Step S62).

Hereafter, the same operation as described above will be executed until a determination result at Step S67 attains NO and when the determination result at Step S67 attains NO, the sequencer 110 sets a flag indicative of operation end to the control register 65 through the internal interface 90 (Step S68).

Upon detecting the flag indicative of operation end (YES at Step S55 in FIG. 5), the processor 1210 which has been cyclically reading the contents of the control register 65 after setting the flag indicative of operation start to the control register 65 conducts processing according to the contents of the search result register 66 and the address register 67 (Step S56).

At Step S56, when, for example, a search result of the first packet classification set at the search result register 66 is hit, read processing contents corresponding to the address information of the first packet classification set at the address register 67 from the storage circuit 1220 and connect an expansion header with the processing contents stored in the packet header.

On the other hand, when miss is set at the search result register 66, connect a dummy header. This processing will be repeated as many times as the number of times of executed packet classification to output an ultimately generated packet header to the packet header input/output interface 1230 (Step S57).

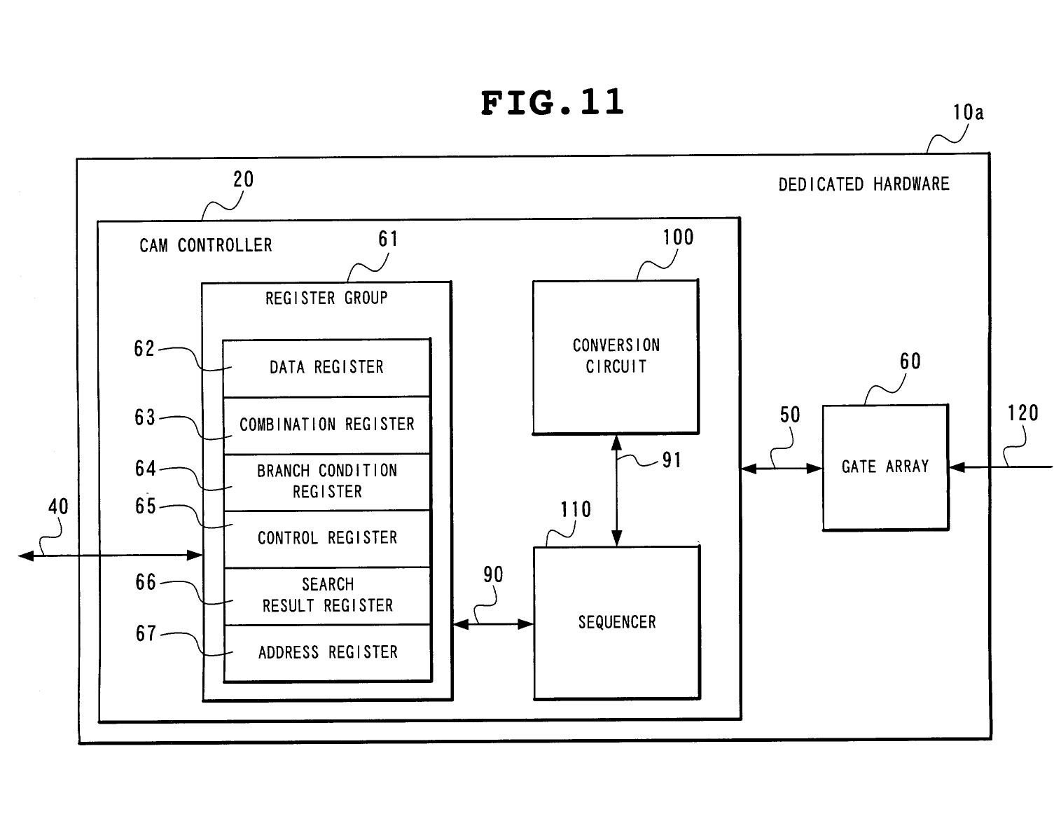

Next, a second embodiment of the present invention will be described. The present embodiment is realized by using, in the packet forwarding processing device 1200 illustrated in FIG. 1, dedicated hardware 10a having the structure shown in FIG. 11 in place of the dedicated hardware 10.

As illustrated in FIG. 11, the dedicated hardware 10a of the second embodiment is composed of a CAM controller 20 and a gate array 60, with the CAM controller 20 having an external interface 40 and the CAM controller 20 and the gate array 60 being connected with each other through an internal interface 50. The CAM controller 20 operates in the same manner as in the first embodiment. In the following, structure and operation of the gate array 60 will be described in detail.

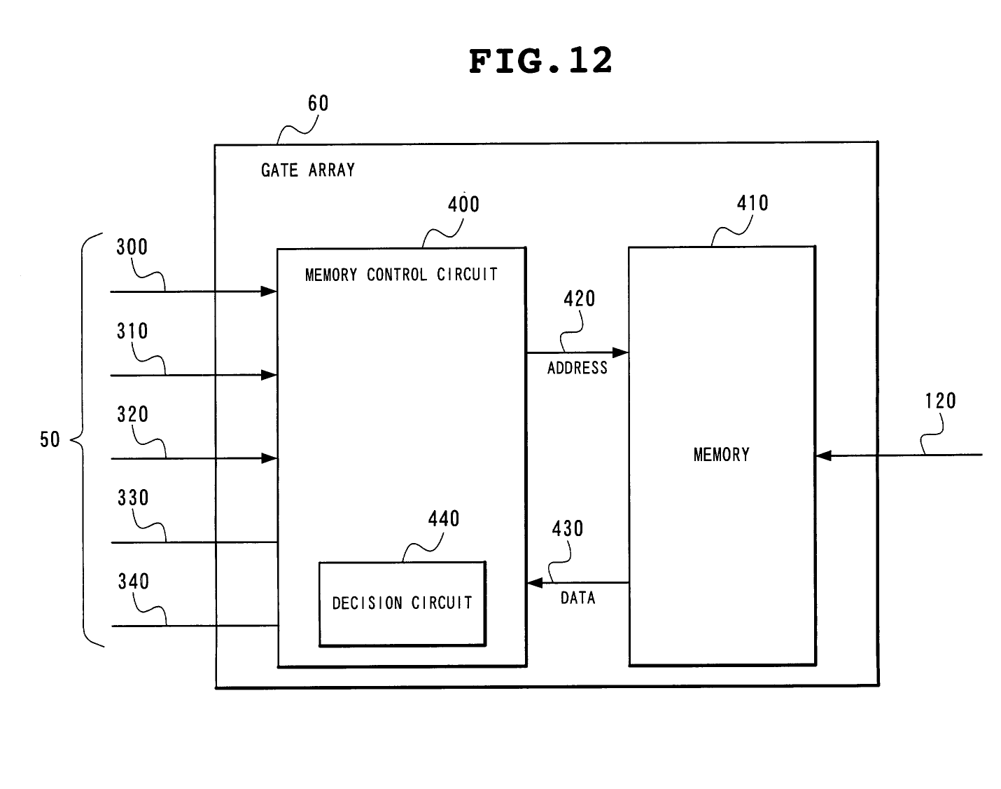

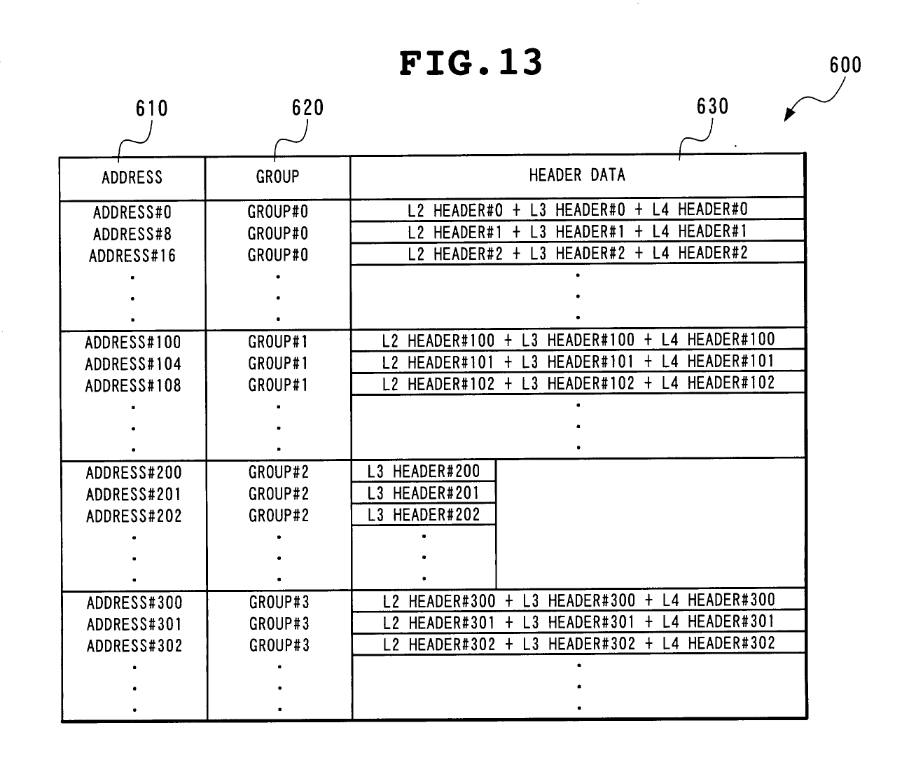

An example of a structure of the gate array 60 is shown in the block diagram of FIG. 12. The gate array 60 includes a memory control circuit 400 having a decision circuit 440 provided therein, and a memory 410. The memory 410 holds data 600 in memory as shown in FIG. 13. Data 600 in memory is composed of a memory address 610, a classification condition group 620 and header data 630.

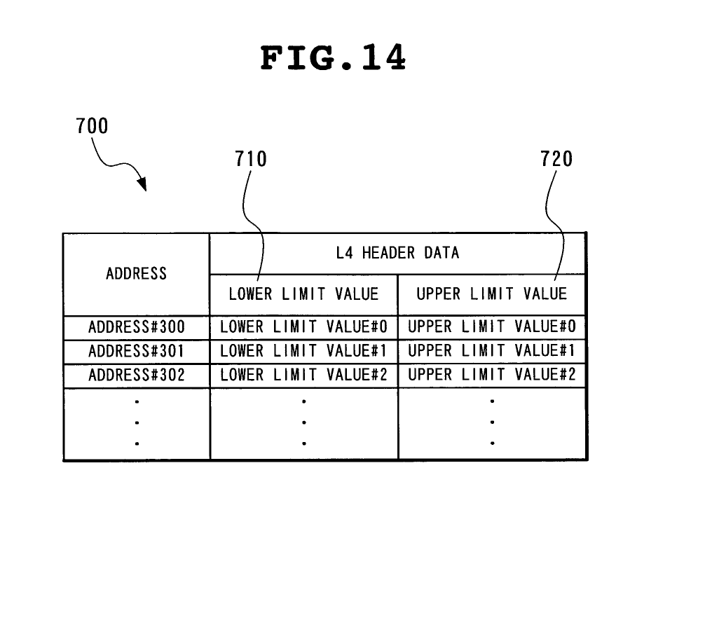

In the header data 630, L4 header data 700 of groups #0, #1 and #3 is made up of such an upper limit value 720 and a lower limit value 710 as shown in FIG. 14. FIG. 14, in which memory addresses are assumed to be addresses #300, #301, . . . assigned to the group #3, shows how an L4 header of the group #3 is stored.

In addition, a group #2 is a group for packet classification requiring only an L3 header, for which only the L3 header is set as packet classification conditions. Thus, by registering only a field necessary for packet classification as a packet classification condition, efficient use of memory is possible.

Upon receiving processing start from a sequencer 110 through a search control line 300, the memory control circuit 400 outputs a memory address at which data of a group designated through a group designation data line 320 is stored to a memory address line 420 in ascending order of its value. On the other hand, the memory 410 outputs memory data stored at the memory address received through the memory address line 420 to a memory data line 430.

Responsively, the memory control circuit 400 conducts comparison processing at the decision circuit 440 between the data received through the memory data line 430 and packet classification condition data received from a packet classification condition data line 310. The memory control circuit 400 thus conducts comparison processing to repeat the same until the data completely coincide with each other or up to the last address at which data of a designated group is stored.

As a result of the comparison processing, when coincident data exists, output hit onto a search result data line 330 and the memory address 610 at which the coincident data is stored onto a search address data line 340 and when no coincident data exists, output miss onto the search result data line 330.

When the output to the search result data line 330 and the search address data line 340 is completed, notify the sequencer 110 of the end of operation through the search control line 300. Operation hereafter is the same as that of the first embodiment.

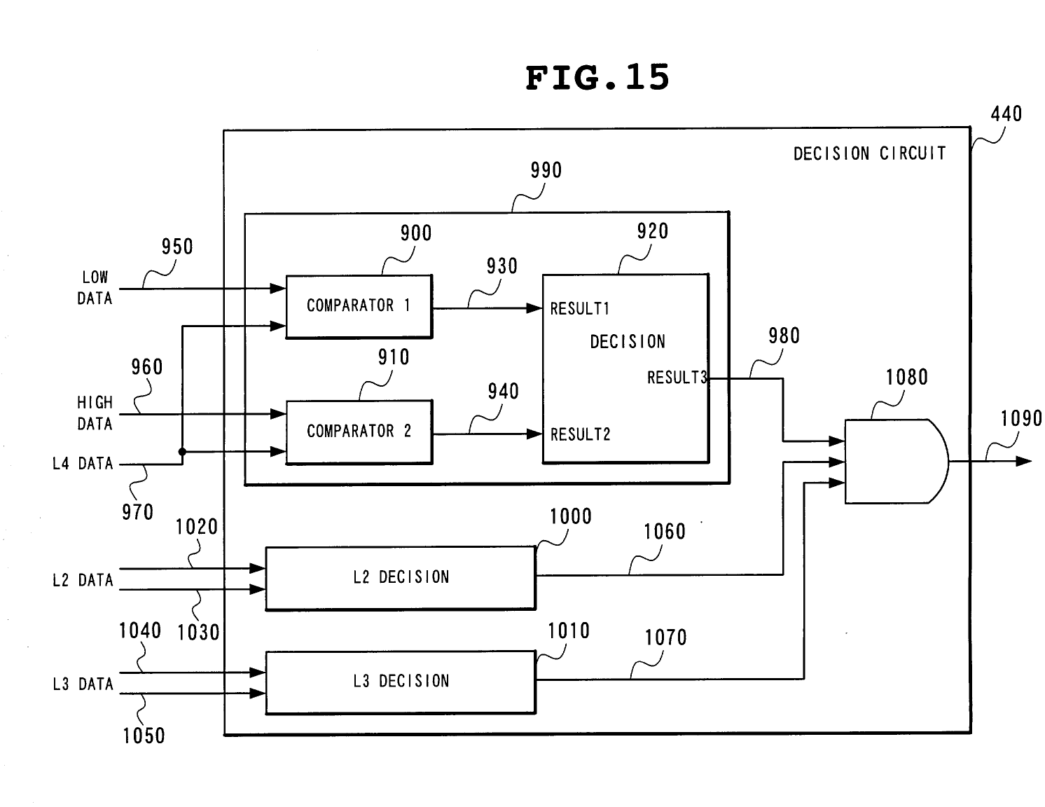

Next, an example of a structure of the decision circuit 440 for making determination of packet classification in the second embodiment is shown in FIG. 15.

The decision circuit 440 includes an L2 decision unit 1000, an L3 decision unit 1010, an L4 decision unit 990 and an AND circuit 1080.

The L2 decision unit 1000 conducts comparison decision between the L2 header data in the header data 630 input through the memory data line 430 and through an L2 classification condition signal 1020 and an L2 classification condition data signal 1030 in the data input to the memory control circuit 400 through the packet classification condition data line 310 and when they completely coincide with each other, outputs “High” indicative of hit and when they fail to coincide with each other completely, outputs “Low” indicative of miss to an L2 decision output signal 1060.

Similarly, the L3 decision unit 1010 conducts comparison decision between the L3 classification condition data in the header data 630 input through the memory data line 430 and through an L3 classification condition signal 1040 and an L3 classification condition data signal 1050 in the data input to the memory control circuit 400 through the packet classification condition data line 310 and when they completely coincide with each other, outputs “High” indicative of hit and when they fail to coincide with each other completely, outputs “Low” indicative of miss to an L3 decision output signal 1070.

Furthermore, the L4 decision unit 990 includes comparators 900 and 910 and a decision unit 920, and the comparator 900 compares an L4 lower limit value input through the memory data line 430 and through an L4 classification condition lower limit value signal 950 and an L4 classification condition data signal 970 in the data input to the memory control circuit 400 through the packet classification condition data line 310.

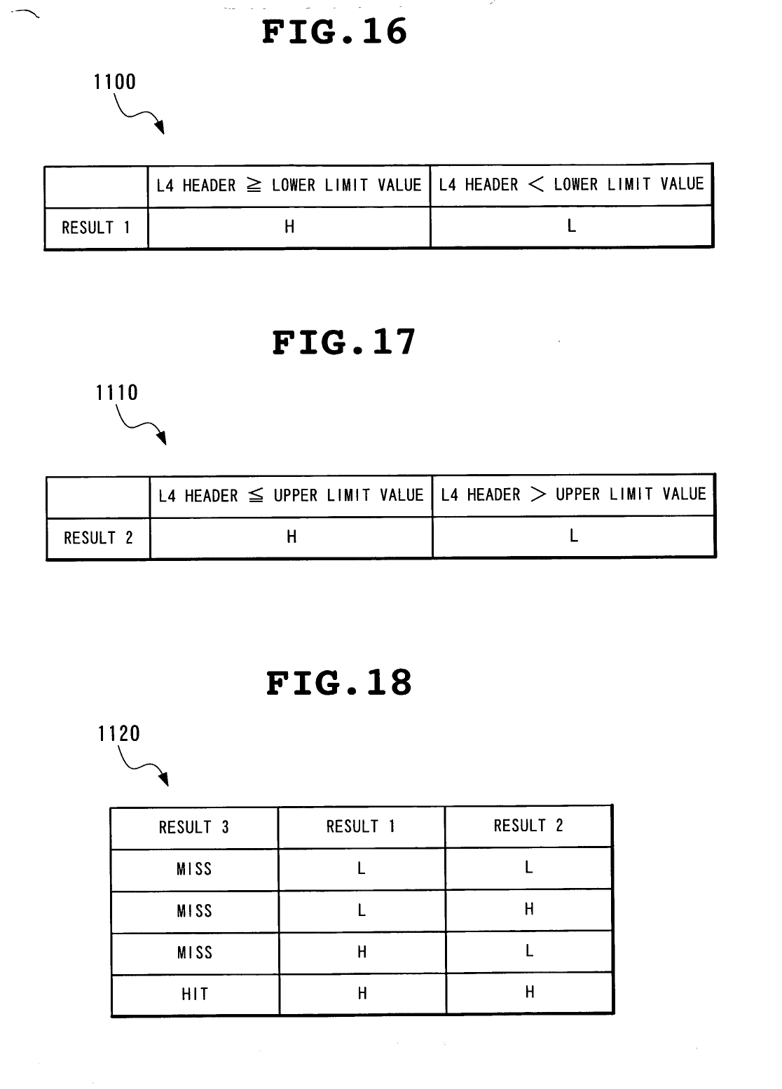

Relationship between input and output of the decision unit 900 is shown in FIG. 16. As shown in an input/output table 1100 of the figure, when the value of the L4 classification condition data signal 970 is not less than the L4 lower limit value 710, output “High” to a comparison output signal 930 and when the value of the L4 classification condition data signal 970 is less than the L4 lower limit value 710, output “Low” to the comparison output signal 930.

Similarly, the comparator 910 compares the L4 upper limit value 720 input through an L4 classification condition upper limit value signal 960 and the L4 classification condition data signal 970.input to the memory control circuit 400 through the packet classification condition data line 310.

Relationship between input and output of the decision unit 910 is shown in FIG. 17. As shown in an input/output table 1110 of the figure, when the value of the L4 classification condition data signal 970 is not more than the L4 upper limit value 720, output “High” to a comparison output signal 940 and when the value of the L4 classification condition data signal 970 is more than the L4 upper limit value 720, output “Low” to the comparison output signal 940.

The succeeding stage decision unit 920 outputs an L4 decision output signal 980 in response to the applied two comparison output signals 930 and 940 according to a truth table 1120 shown in FIG. 18. As illustrated in the truth table 1120 of the figure, only when the applied two comparison output signals 930 and 940 are at “High”, the decision unit 920 outputs “High” to the L4 decision output signal 980 and otherwise, outputs “Low”. Lastly, the three signals, the L4 decision output signal 980, the L2 decision output signal 1060 and the L3 decision output signal 1070 are output as a classification decision output signal 1090 through the AND circuit 1080.

The packet forwarding processing device according to the present invention attains the conspicuous effects set forth below.

The first effect is enabling a packet forwarding processing device which successively conducts packet classification using different search keys a plurality of times to add new packet classification using different search keys or change of a search key without modifying hardware. The reason is that combination information indicative of a combination of fields of header information for each of a plurality of kinds of packet classifications can be designated outside of hardware.

The second effect is enabling the order of a plurality of packet classifications using different search keys to be dynamically changed. The reason is that branch condition information indicative of a corresponding relationship between a result of packet classification and processing to be executed next can be designated outside of hardware.

The third effect is enabling efficient use of a storage region provided in dedicated hardware for storing packet classification conditions. One reason is that a storage region is designed to store only a value of a field necessary for packet classification among respective fields of header information of a packet as packet classification conditions. The other reason is that when a certain field of packet classification conditions is designated as a range of numerical values as its classification conditions, an upper limit value and a lower limit value of the range of the numerical values are stored in a storage region as packet classification conditions.

Although the invention has been illustrated and described with respect to exemplary embodiment thereof, it should be understood by those skilled in the art that the foregoing and various other changes, omissions and additions may be made therein and thereto, without departing from the spirit and scope of the present invention. Therefore, the present invention should not be understood as limited to the specific embodiment set out above but to include all possible embodiments which can be embodies within a scope encompassed and equivalents thereof with respect to the feature set out in the appended claims.

In the claims:

1. A packet forwarding processing device having a packet classifier for executing, based on header information of an applied packet and a plurality of predetermined packet classification conditions, a plurality of kinds of packet classifications using different search keys with respect to said packet, wherein
said packet classifier including
means for generating a search key for use in each of said plurality of kinds of packet classifications based on combination information indicative of a combination of fields of header information for each of said plurality of kinds of packet classifications externally designated and the header information of said packet.

2. The packet forwarding processing device as set forth in claim 1, wherein
said packet classifier has a storage region for storing a plurality of packet classification conditions,
said storage region storing only a value of a field necessary for packet classification among the respective fields of header information of a packet as packet classification conditions.

3. The packet forwarding processing device as set forth in claim 2, wherein
said packet classification conditions include a numerical value range represented by a lower limit value and an upper limit value, and
as to a part of the numerical value range in said packet classification conditions, when a numerical value indicated by a relevant part of a search key falls within said numerical value range, said packet classifier determines that the part of said numerical value range in said packet classification conditions and the relevant part of said search key coincide with each other.

4. A packet forwarding processing device having a packet classifier for executing, based on header information of an applied packet and a plurality of predetermined packet classification conditions, a plurality of kinds of packet classifications using different search keys with respect to said packet, wherein
said packet classifier including
means for, at every execution of packet classification, based on a result of the executed processing and branch condition information indicative of a corresponding relationship between a result of each of said kinds of packet classifications externally designated and processing to be executed next, ending processing of said packet or executing packet classification of a kind instructed to be executed next by said branch condition information.

5. The packet forwarding processing device as set forth in claim 4, wherein
said packet classifier has a storage region for storing a plurality of packet classification conditions,
said storage region storing only a value of a field necessary for packet classification among the respective fields of header information of a packet as packet classification conditions.

6. The packet forwarding processing device as set forth in claim 5, wherein
said packet classification conditions include a numerical value range represented by a lower limit value and an upper limit value, and
as to a part of the numerical value range in said packet classification conditions, when a numerical value indicated by a relevant part of a search key falls within said numerical value range, said packet classifier determines that the part of said numerical value range in said packet classification conditions and the relevant part of said search key coincide with each other.

7. A packet forwarding processing device having a packet classifier for executing, based on header information of an applied packet and a plurality of predetermined packet classification conditions, a plurality of kinds of packet classifications using different search keys with respect to said packet, wherein
said packet classifier including
means for, at every execution of packet classification, based on a result of the executed processing and branch condition information indicative of a corresponding relationship between a result of each of said kinds of packet classifications externally designated and processing to be executed next, ending processing of said packet, or executing packet classification of a kind instructed to be executed next by said branch condition information by using a search key generated based on said header information and combination information indicative of a combination of fields of header information for each of said plurality of kinds of packet classifications externally designated.

8. The packet forwarding processing device as set forth in claim 7, wherein
said packet classifier has a storage region for storing a plurality of packet classification conditions,
said storage region storing only a value of a field necessary for packet classification among the respective fields of header information of a packet as packet classification conditions.

9. The packet forwarding processing device as set forth in claim 8, wherein
said packet classification conditions include a numerical value range represented by a lower limit value and an upper limit value, and
as to a part of the numerical value range in said packet classification conditions, when a numerical value indicated by a relevant part of a search key falls within said numerical value range, said packet classifier determines that the part of said numerical value range in said packet classification conditions and the relevant part of said search key coincide with each other.

10. A packet classifier for executing, based on header information of an applied packet and a plurality of predetermined packet classification conditions, a plurality of kinds of packet classifications using different search keys with respect to said packet, comprising:
means for generating a search key for use in each of said plurality of kinds of packet classifications based on combination information indicative of a combination of fields of header information for each of said plurality of kinds of packet classifications externally designated and the header information of said packet.

11. The packet classifier as set forth in claim 10,
which has a storage region for storing a plurality of packet classification conditions,
said storage region storing only a value of a field necessary for packet classification among the respective fields of header information of a packet as packet classification conditions.

12. The packet classifier as set forth in claim 11, wherein
said packet classification conditions include a numerical value range represented by a lower limit value and an upper limit value, and
as to a part of the numerical value range in said packet classification conditions, when a numerical value indicated by a relevant part of a search key falls within said numerical value range, said packet classifier determines that the part of said numerical value range in said packet classification conditions and the relevant part of said search key coincide with each other.

13. A packet classifier for executing, based on header information of an applied packet and a plurality of predetermined packet classification conditions, a plurality of kinds of packet classifications using different search keys with respect to said packet, comprising:
means for, at every execution of packet classification, based on a result of the executed processing and branch condition information indicative of a corresponding relationship between a result of each of said kinds of packet classifications externally designated and processing to be executed next, ending processing of said packet or executing packet classification of a kind instructed to be executed next by said branch condition information.

14. The packet classifier as set forth in claim 13,
which has a storage region for storing a plurality of packet classification conditions,
said storage region storing only a value of a field necessary for packet classification among the respective fields of header information of a packet as packet classification conditions.

15. The packet classifier as set forth in claim 14, wherein
said packet classification conditions include a numerical value range represented by a lower limit value and an upper limit value, and
as to a part of the numerical value range in said packet classification conditions, when a numerical value indicated by a relevant part of a search key falls within said numerical value range, said packet classifier determines that the part of said numerical value range in said packet classification conditions and the relevant part of said search key coincide with each other.

16. A packet classifier for executing, based on header information of an applied packet and a plurality of predetermined packet classification conditions, a plurality of kinds of packet classifications using different search keys with respect to said packet, comprising:
means for, at every execution of packet classification, based on a result of the executed processing and branch condition information indicative of a corresponding relationship between a result of each of said kinds of packet classifications externally designated and processing to be executed next, ending processing of said packet, or executing packet classification of a kind instructed to be executed next by said branch condition information by using a search key generated based on said header information and combination information indicative of a combination of fields of header information for each of said plurality of kinds of packet classifications externally designated.

17. The packet classifier as set forth in claim 16,
which has a storage region for storing a plurality of packet classification conditions,
said storage region storing only a value of a field necessary for packet classification among the respective fields of header information of a packet as packet classification conditions.

18. The packet classifier as set forth in claim 17, wherein
said packet classification conditions include a numerical value range represented by a lower limit value and an upper limit value, and
as to a part of the numerical value range in said packet classification conditions, when a numerical value indicated by a relevant part of a search key falls within said numerical value range, said packet classifier determines that the part of said numerical value range in said packet classification conditions and the relevant part of said search key coincide with each other.
